(19) United States
(12) Patent Application Publication
(10) Pub. No.: US 2016/0134316 A1
(43) Pub. Date: May 12, 2016

(54) System and Methods for Enabling MIMO Operation During Inactive SIM State on a Multi-SIM Wireless Communication Device

(71) Applicant: QUALCOMM Incorporated, San Diego, CA (US)

(72) Inventors: Prashanth Mohan, Chennai (IN); Parthasarathy Krishnamoorthy, Hyderabad (IN); Krishnakumar Vasanthasenan, Hyderabad (IN); Vamsi Krishna Potti, Hyderabad (IN); Raju Kasaramoni, Hyderabad (IN)

(21) Appl. No.: 14/538,975

(22) Filed: Nov. 12, 2014

(51) Int. Cl. H04B 1/3816; H04B 7/04

(52) U.S. Cl. CPC H04B 1/3816; H04B 7/0413

(57) ABSTRACT

Methods and devices are disclosed for managing multiple-input multiple-output (MIMO) mode on a multi-SIM wireless device. The wireless device may determine whether all of the SIMs are in an active state, and identify each active SIM and each RF resource that is associated with an inactive SIM if less than all of the SIMs are in the active state. The wireless device may determine whether at least one identified active SIM and at least one identified RF resource satisfy MIMO criteria. Upon determining that at least one identified active SIM and at least one identified RF resource satisfy the MIMO criteria, the wireless device may allocate, for use in MIMO operations, the at least one identified RF resource to a protocol stack associated with a selected one of the at least one identified active SIM.

### BACKGROUND

Multi-subscriber identification module (SIM) wireless devices have become increasing popular because of the versatility that they provide, particularly in countries where there are many service providers. For example, dual-SIM wireless devices may allow a user to implement two different plans or service providers, with separate numbers and bills, on the same device (e.g., business account and personal account). Also, during travel, users can obtain local SIM cards and pay local call rates in the destination country. By using multiple SIMs, a user may take advantage of different pricing plans and save on mobile data usage.

In various types of multi-SIM wireless communication devices, each modem stack associated with a subscription may store information provisioned by its respective network operator in a SIM, which may allow the SIM to support use of various different communication services. For example, various wireless networks may be configured to handle different types of data, use different communication modes, implement different radio access technologies, etc. One type of multi-SIM wireless device, referred to as a dual-SIM dual-active (DSDA) device, allows simultaneous active connections with the networks corresponding to two SIMs using separate transmit/receive chains associated with each SIM.

In a DSDA device, each SIM may be associated with a separate radio frequency (RF) resource, thereby allowing the DSDA device to simultaneously connect to and communicate on both networks. In particular, such communications may be enabled by implementing on a modem/processor an independent protocol stack for each SIM in the DSDA device.

In some DSDA devices, information stored on a SIM of a DSDA device may enable use of advanced wireless communications interface technologies. While such advanced technologies may provide increased speed to improve various user experiences (e.g., high data rates, streaming high-bandwidth media, complex applications, etc.), they may also require increased capacity on the receiver of the wireless device.

An ongoing goal of mobile communications is achieving high speed rates of data transmission and reception. One technology used for high speed data is multiple-input multiple-output (MIMO) operation in which multiple, spaced apart antennas on the receiver and transmitter are used to receive and/or transmit wireless signals at the same time. MIMO operation takes advantage of receiving signals along multiple, different paths (multipath) that adds a spatial dimension to signal reception, which can be used in processing the received signals to increase performance. However, in order to enable MIMO operation for a SIM in a conventional DSDA device, multiple receive elements must be available for the communication on that SIM, which may add hardware costs to the device. Further, during times in which the benefits of MIMO operation may be unneeded or underutilized, the added power cost and delays associated with implementing MIMO may not be warranted.

In current DSDA devices, while both RF resources may support a high speed wireless communication standard (e.g., LTE), when one SIM is not functioning, the DSDA device is not configured to use (or be aware of) the associated inactive RF resource since the SIMs operate independently through separate protocol stacks. Thus, a conventional DSDA device may operate inefficiently when one SIM is inactive since resources that are available for high speed data rates are left unused. Therefore, when one SIM is inactive, the DSDA device may not be using its RF capabilities to the fullest potential. Some DSDA devices may therefore benefit from the use of multiple antennas and/or other RF receive chain components, i.e., as “receive diversity.” Specifically, in some DSDA devices, receive diversity may provide dramatic improvement in data throughput, and may prevent dropped calls in weak coverage areas.

### SUMMARY

Systems, methods, and devices of various embodiments enable a multi-SIM wireless communication device having at least two SIMs to dynamically activate a dynamic multiple-input multiple-output (MIMO) mode by determining whether all of the SIMs are in an active state, and identifying each active SIM and each RF resource associated with an inactive SIM. Systems, methods and devices of various embodiments further include, in response to determining that not all of the SIMs are in the active state, determining whether at least one identified active SIM and at least one identified RF resource satisfy MIMO criteria, and allocating, for use in MIMO operations, the at least one identified RF resource to a protocol stack associated with a selected one of the at least one identified active SIM in response to determining that at least one identified active SIM and at least one identified RF resource satisfy the MIMO criteria.

In some embodiment methods and devices, determining whether at least one identified RF resource satisfies the MIMO criteria includes determining, for each identified RF resource, whether communication activity is normally mapped to a protocol stack associated with a single SIM. Systems, methods and devices of various embodiments further include obtaining information about the identified RF resources, which includes, for each identified RF resource, a set of radio access technologies supported by the inactive RF resource; and a set of service provider networks in which the protocol stack associated with the single SIM can register. Systems, methods and devices of various embodiments further include storing the obtained information about the identified RF resources associated with an inactive SIM.

In some embodiment methods and devices, determining whether at least one identified active SIM satisfies the MIMO criteria includes determining, for each identified active SIM, whether an associated protocol stack is operating in a high-speed communication network, and for each identified active SIM operating in a high-speed communication network, determining whether the associated protocol stack is camped for both voice and data service on a serving cell of the high-speed communication network;

In some embodiment methods and devices, at least one communication protocol implemented by the high-speed communication network uses long term evolution (LTE), evolved high-speed packet access (HSPA+), worldwide interoperability for microwave access (WiMAX), or IEEE 802.11 (Wi-Fi).

### BRIEF DESCRIPTION OF THE DRAWINGS

The accompanying drawings, which are incorporated herein and constitute part of this specification, illustrate exemplary embodiments of the invention, and together with the general description given above and the detailed description given below, serve to explain the features of the invention.

FIG. 1A is a communication system block diagram of a network suitable for use with the various embodiments.

FIG. 1B is system block diagram of an Evolved Packet System (EPS) suitable for use with the various embodiments.

FIG. 2 is a block diagram illustrating a dual-SIM dual-active wireless communication device according to various embodiments.

FIG. 3 is a block diagrams illustrating an example configurations of elements that are associated with implementing dynamic MIMO capability on a multi-SIM wireless communication device according to various embodiments.

FIGS. 4A and 4B are processor flow diagrams illustrating a method for implementing dynamic MIMO management in an example dual-SIM wireless communication device according to various embodiments.

FIG. 5 is a component diagram of an example wireless device suitable for use with various embodiments.

FIG. 6 is a component diagram of another example wireless device suitable for use with various embodiments.

### DETAILED DESCRIPTION

The various embodiments will be described in detail with reference to the accompanying drawings. Wherever possible, the same reference numbers will be used throughout the drawings to refer to the same or like parts. References made to particular examples and implementations are for illustrative purposes, and are not intended to limit the scope of the invention or the claims.

In various embodiments, certain technologies may gain use of an additional RF resource that is not being used by an inactive SIM to provide MIMO operation on an active SIM. MIMO operation may be dynamically applied based on a MIMO management scheme implemented through a MIMO manager software module. In particular, the dynamic MIMO scheme in various embodiments may involve determining, by the dynamic MIMO manager, whether to permit a protocol stack associated with an active SIM to utilize an additional RF resource that is normally associated with a currently-inactive SIM. This determination may be made based on various criteria about the SIMs and RF resources (referred to herein as “MIMO criteria”). Such criteria may include, for example, the radio access technologies supported by the RF resources, capabilities of the serving network, current radio/mobility modes on the active SIM protocol stack, etc.

The terms “wireless device,” “mobile device,” and “wireless communication device” are used interchangeably herein to refer to any one or all of cellular telephones, smart phones, personal or mobile multi-media players, personal data assistants (PDAs), laptop computers, tablet computers, smart books, palm-top computers, wireless electronic mail receivers, multimedia Internet enabled cellular telephones, wireless gaming controllers, and similar personal electronic devices that include a programmable processor and memory and circuitry for establishing wireless communication pathways and transmitting/receiving data via wireless communication pathways enabled by two or more SIMs.

As used herein, the terms “SIM,” “SIM card,” and “subscriber identification module” are used interchangeably to refer to a memory that may be an integrated circuit or embedded into a removable card, and that stores an International Mobile Subscriber Identity (IMSI), related key, and/or other information used to identify and/or authenticate a wireless device on a network and enable a communication service with the network. Because the information stored in a SIM enables the wireless device to establish a communication link for a particular communication service or services with a particular network, the term “SIM” is also be used herein as a shorthand reference to the communication service associated with and enabled by the information stored in a particular SIM as the SIM and the communication network, as well as the services and subscriptions supported by that network, correlate to one another. Similarly, the term SIM may also be used as a shorthand reference to the protocol stack and/or modem stack and communication processes used in establishing and conducting communication services with subscriptions and networks enabled by the information stored in a particular SIM. For example, references to assigning an RF resource to a SIM (or granting a SIM radio access) means that the RF resource has been allocated to establishing or using a communication service with a particular network that is enabled by the information stored in that SIM.

As used herein, the terms “multi-SIM wireless communication device,” “multi-SIM wireless device,” “dual-SIM wireless communication device,” “dual-SIM dual-active device,” and “DSDA device” are used interchangeably to describe a wireless device that is configured with more than one SIM and is capable of independently handling communications with networks of two or more subscriptions.

The terms “wireless network,” “cellular network,” and “cellular wireless communication network” are used interchangeably herein to refer to a portion or all of a wireless network of a carrier associated with a wireless device and/or subscription on a wireless device.

The terms “multiple-input multiple-output” and “MIMO” are used interchangeably herein to refer to a technology that multiplies the capacity of a radio link by exploiting multipath propagation. In particular, a wireless communication device operating in MIMO mode employs multiple RF chains to receive and combine data streams arriving from different downlink paths, and/or to create multiple data streams for transmission on different uplink paths. When there are more antennas than data streams, the antennas can add receiver diversity and increase range.

As used herein, the terms “diversity,” “receive diversity,” “diversity reception,” and “receiver diversity” are used interchangeably to refer to processing a downlink/forward link signal by input to multiple receive chains in a wireless communication device. For example, at least two antennas provide at least two different inputs signals to a receiver, each of which has a different multi-path.

Wireless communication networks are widely deployed to provide various communication services such as voice, packet data, broadcast, messaging, and so on. These wireless networks may be capable of supporting communications for multiple users by sharing the available network resources. Examples of such wireless networks include the Global System for Mobile Communications (GSM), Code Division Multiple Access (CDMA) networks, Time Division Multiple Access (TDMA) networks, and Frequency Division Multiple Access (FDMA) networks. Wireless networks may also utilize various radio technologies such as Wideband-CDMA (W-CDMA), CDMA2000, Global System for Mobile Communications (GSM), etc. While reference may be made to procedures set forth in GSM standards such references are provided merely as examples, and the claims encompass other types of cellular telecommunication networks and technologies.

Modern mobile communication devices (e.g., smartphones) may now each include a plurality of SIM cards containing SIMs that enable a user to connect to different mobile networks while using the same mobile communication device. Each SIM serves to identify and authenticate a subscriber using a particular mobile communication device, and each SIM is associated with only one subscription. For example, a SIM may be associated with a subscription to one of GSM, TD-SCDMA, CDMA2000, and WCDMA. With a DSDA device, a user may maintain two subscriptions because the mobile communication device has two SIMs. These subscriptions may have their own radio frequency (RF) resource (e.g., transceiver) and may, therefore, simultaneously connect to each of their respective mobile network.

Controlling spatial multiplexing through use of MIMO diversity may be applicable to any of a number of wireless communication system, using various multiple access schemes, such as, but not limited to, Code Division-Multiple Access (CDMA), Frequency Division-Multiple Access (FDMA), Orthogonal Frequency Division Multiplexing (OFDM) or Time Division-Multiple Access (TDMA). Examples of CDMA multiple access schemes include but are not limited to TIA/EIA/IS-95, TIA/EIA/IS-2000 or CDMA2000, 1×EV-DO, 1×EV-DV, 802.11a, 802.11b, 802.11g, 802.11n, 802.11ac, WIMAX, and WCDMA. Embodiments described herein may also extend to Long Term Evolution (LTE) wireless communication systems. The embodiments described herein may be used in any wireless system having two or more antennas coupled to two or more RF resources, and paired to corresponding RF resources implemented by the a serving network entity (e.g., an eNodeB).

While specific MIMO operations may be described herein with reference to a degree of two (i.e., two RF resources, two antennas, two RF chains, etc.), such references are used as example and are not meant to preclude embodiments using three or more RF resources to support MIMO. The terms “receiver” and/or “transmitter” may indicate an RF chain and/or portions of the RF receive chain in use for radio links. Such portions of the RF chain may include, without limitation, an RF front end, components of the RF front end (including a receiver unit and/or transmitter unit), antennas, etc. Portions of the RF chain may be integrated into a single chip, or distributed over multiple chips. Also, the RF resource, the RF chain, or portions of the RF chain may be integrated into a chip along with other functions of the wireless device. Further, in some embodiment wireless systems, the wireless communication device may be configured with more RF chains than spatial streams, thereby enabling receive and/or transmit diversity to improve signal quality.

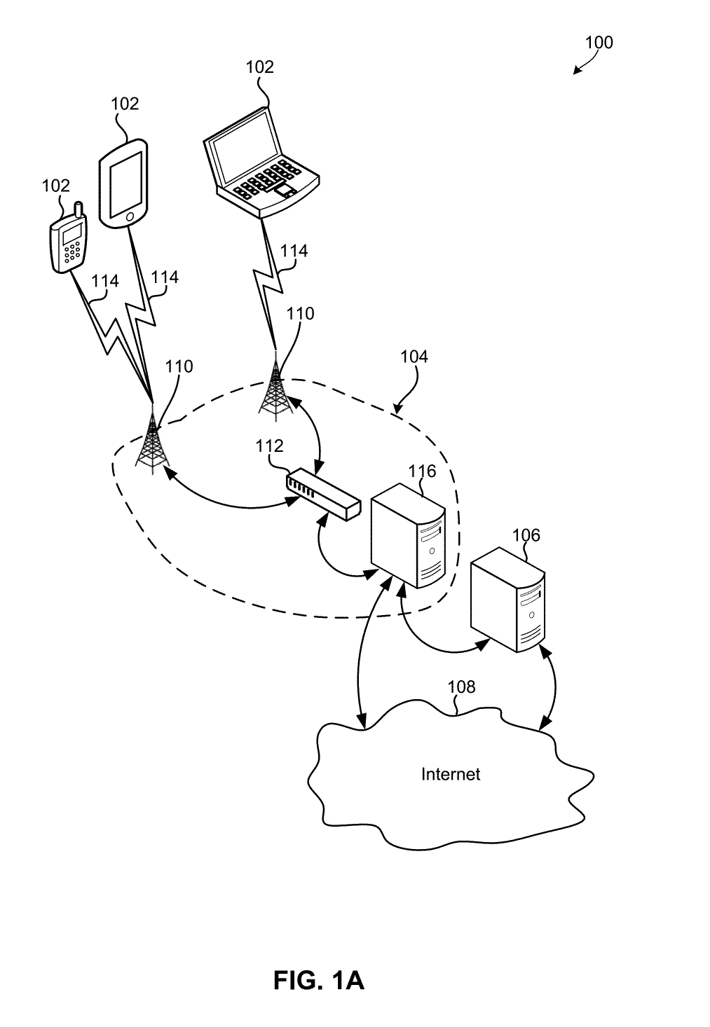

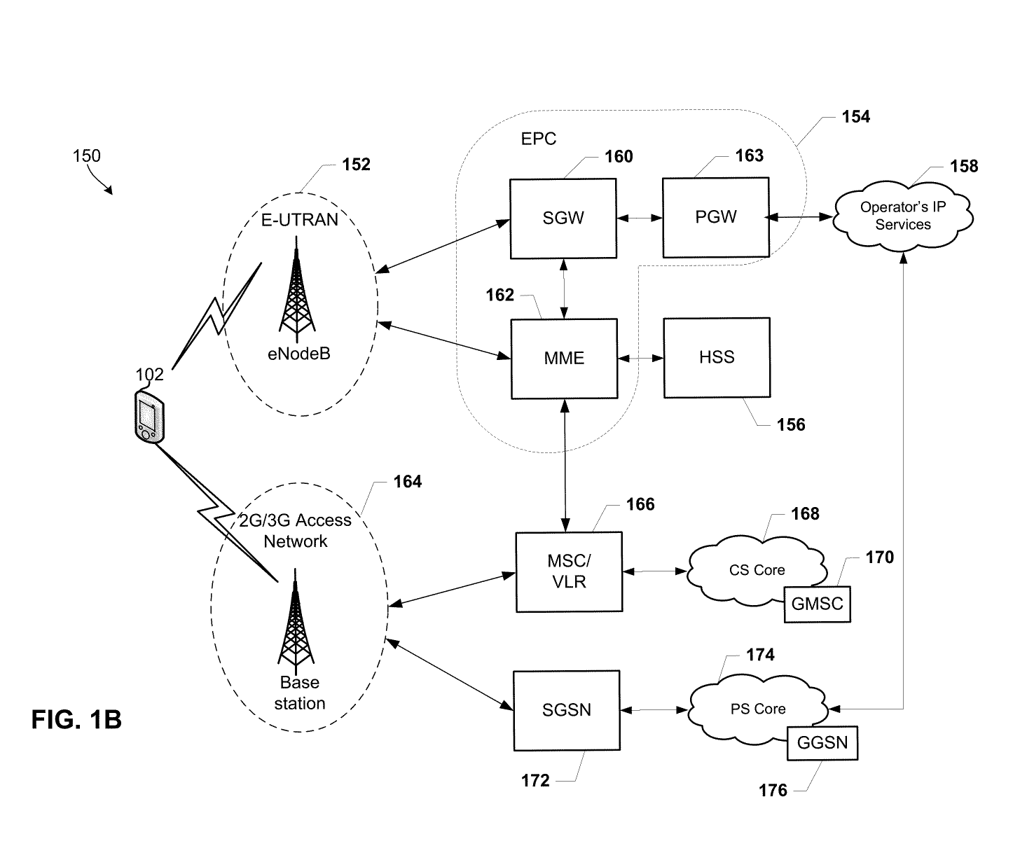

Various embodiments may be implemented within a variety of communication systems, such as the example communication system 100 illustrated in FIG. 1A. The communication system 100 may include one or more wireless devices 102, a telephone network 104, and network servers 106 coupled to the telephone network 104 and to the Internet 108. In some embodiments, the network server 106 may be implemented as a server within the network infrastructure of the telephone network 104.

A typical telephone network 104 may include a plurality of cell base stations 110 coupled to a network operations center 112, which operates to connect voice and data calls between the wireless devices 102 (e.g., tablets, laptops, cellular phones, etc.) and other network destinations, such as via telephone land lines (e.g., a POTS network, not shown) and the Internet 108. The telephone network 104 may also include one or more servers 116 coupled to or within the network operations center 112 that provide a connection to the Internet 108 and/or to the network servers 106. Communications between the wireless devices 102 and the telephone network 104 may be accomplished via two-way wireless communication links 114, such as GSM, UMTS, EDGE, 4G, 3G, CDMA, TDMA, LTE, and/or other communication technologies.

In general, any number of wireless networks may be deployed in a given geographic area. Each wireless network may support one or more radio access technology (RAT), which may operate on one or more frequency (also referred to as a carrier, channel, frequency channel, etc.) in the given geographic area in order to avoid interference between wireless networks of different RATs.

Upon power up, the wireless device 102 may search for wireless networks from which the wireless device 102 can receive communication service. In various embodiments, the wireless device 102 may be configured to prefer LTE networks when available by defining a priority list in which LTE frequencies occupy the highest spots. The wireless device 102 may perform registration processes on one of the identified networks (referred to as the serving network), and the wireless device 102 may operate in a connected mode to actively communicate with the serving network. Alternatively, the wireless device 102 may operate in an idle mode and camp on the serving network if active communication is not required by the wireless device 102. In the idle mode, the wireless device 102 may identify all RATs in which the wireless device 102 is able to find a “suitable” cell in a normal scenario or an “acceptable” cell in an emergency scenario, as specified in the LTE standards, such as 3GPP TS 36.304 version 8.2.0 Release 8, entitled “LTE; Evolved Universal Terrestrial Radio Access (E-UTRA); User Equipment (UE) procedures in idle mode.”

The wireless device 102 may camp on a cell belonging to the RAT with the highest priority among all identified. The wireless device 102 may remain camped until either the control channel no longer satisfies a threshold signal strength or a cell of a higher priority RAT reaches the threshold signal strength. Such cell selection/reselection operations for the wireless device 102 in the idle mode are also described in 3GPP TS 36.304 version 8.2.0 Release 8.

FIG. 1B illustrates a network architecture 150 that includes an Evolved Packet System (EPS). With reference to FIGS. 1A-1B, in the network architecture 150 the wireless communication device 102 may be connected to an LTE access network, for example, an Evolved UMTS Terrestrial Radio Access Network (E-UTRAN) 152. In the various embodiments, the E-UTRAN 152 may be a network of LTE base stations (i.e., eNodeBs) (e.g., 110 in FIG. 1A), which may be connected to one another via an X2 interface (e.g., backhaul) (not shown).

In various embodiments, each eNodeB may provide to wireless devices an access point to an LTE core (e.g., an Evolved Packet Core). For example, the EPS in the network architecture 150 may further include an Evolved Packet Core (EPC) 154 to which the E-UTRAN 152 may connect. In various embodiments, the EPC 154 may include at least one Mobility Management Entity (MME) 162, a Serving Gateway (SGW) 160, and a Packet Data Network (PDN) Gateway (PGW) 163.

In various embodiments, the E-UTRAN 152 may connect to the EPC 154 by connecting to the SGW 160 and to the MME 162 within the EPC 154. The MME 162, which may also be logically connected to SGW 160, may handle tracking and paging of the wireless device 102 and security for E-UTRAN access on the EPC 154. The MME 162 may be linked to a Home Subscriber Server (HSS) 156, which may support a database containing user subscription, profile, and authentication information. Further, the MME 162 provides bearer and connection management for user IP packets, which are transferred through the SGW 160. In various embodiments, the SGW 160 may be connected to the PGW 163, which may provide IP address allocation to the wireless device 102, as well as other functions. The PGW 163 may be connected to the Operator's IP Services 158, which may include, for example, the Internet, an Intranet, an IP Multimedia Subsystem (IMS), a PS Streaming Service (PSS), etc.

The network architecture 150 may also include circuit-switched (CS) and packet-switched (PS) networks. In some embodiments, the wireless device 102 may be connected to the CS and/or PS packet switched networks by connecting to a legacy 2G/3G access network 164, which may be one or more UTRAN, GSM EDGE Radio Access Network (GERAN), etc. In the various embodiments, the 2G/3G access network 164 may include a network of base stations (e.g., base transceiver stations (BTSs), nodeBs, radio base stations (RBSs), etc.) (e.g., 110), as well as at least one base station controller (BSC) or radio network controller (RNC). In various embodiments, the 2G/3G access network 164 may connect to the circuit switched network via an interface with (or gateway to) a Mobile switching center (MSC) and associated Visitor location register (VLR), which may be implemented together as MSC/VLR 166. In the CS network, the MSC/VLR 166 may connect to a CS core 168, which may be connected to external networks (e.g., the public switched telephone network (PSTN)) through a Gateway MSC (GMSC) 170.

In various embodiments, the 2G/3G access network 164 may connect to the PS network via an interface with (or gateway to) a Serving GPRS support node (SGSN) 172, which may connect to a PS core 174. In the PS network, the PS core 174 may be connected to external PS networks, such as the Internet and the Operator's IP services 158 through a Gateway GPRS support node (GGSN) 176.

A number of techniques may be employed by LTE network operators to enable voice calls to the wireless device 102 when camped on the LTE network (e.g., EPS). The LTE network (e.g., EPS) may co-exist in mixed networks with the CS and PS networks, with the MME 162 serving the wireless device 102 for utilizing PS data services over the LTE network, the SGSN 172 serving the wireless device 102 for utilizing PS data services in non-LTE areas, and the MSC/VLR 166 serving the wireless device 102 for utilizing voice services. In various embodiments, the wireless device 102 may be able to use a single RF resource for both voice and LTE data services by implementing circuit-switched fallback (CSFB) to switch between accessing the E-UTRAN 152 and the legacy 2G/3G access network 164.

The mixed network may be enabled to facilitate circuit switched fallback (CSFB) via an interface (SGs) between the MME 162 and the MSC/VLR 166. The interface enables the wireless device 102 to utilize a single RF resource to be both CS and PS registered while camped on the LTE network, which enables delivery CS pages via the E-UTRAN 152. A CS page may initiate the CSFB procedure, which may cause the wireless device to transition to the CS network and utilize the CS call setup procedures.

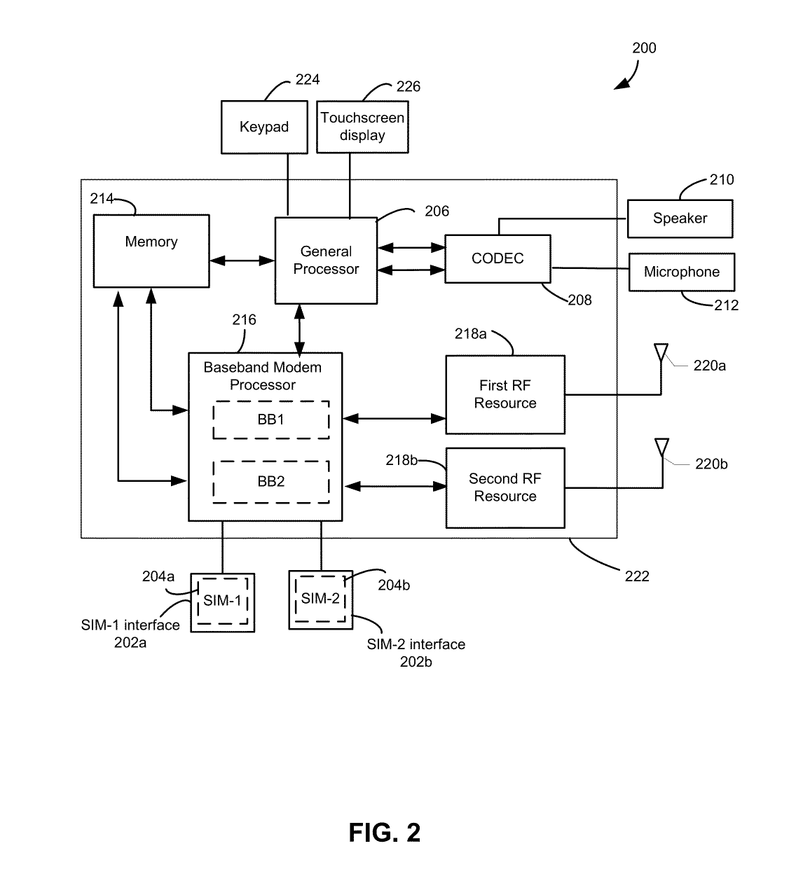

FIG. 2 is a functional block diagram of an example multi-SIM wireless device 200 that is suitable for implementing various embodiments. The wireless device 200 may be similar to one or more of the wireless devices 102, described above with reference to FIGS. 1A and 1B. With reference to FIGS. 1A-2, the wireless device 200 may include a first SIM interface 202a, which may receive a first identity module SIM 204a that is associated with the first subscription. The wireless device 200 may also include a second SIM interface 202b, which may receive a second identity module SIM 204b that is associated with the second subscription.

A SIM in various embodiments may be a Universal Integrated Circuit Card (UICC) that is configured with SIM and/or USIM applications, enabling access to GSM and/or UMTS networks. The UICC may also provide storage for a phone book and other applications. Alternatively, in a CDMA network, a SIM may be a UICC removable user identity module (R-UIM) or a CDMA subscriber identity module (CSIM) on a card.

Each SIM 204a, 204b may have a CPU, ROM, RAM, EEPROM and I/O circuits. A SIM 204a, 204b used in various embodiments may contain user account information, an IMSI a set of SIM application toolkit (SAT) commands and storage space for phone book contacts. A SIM 204a, 204b may further store home identifiers (e.g., a System Identification Number (SID)/Network Identification Number (NID) pair, a Home PLMN (HPLMN) code, etc.) to indicate the SIM network operator provider. An Integrated Circuit Card Identity (ICCID) SIM serial number may be printed on the SIM card for identification.

The wireless device 200 may include at least one controller, such as a general purpose processor 206, which may be coupled to a coder/decoder (CODEC) 208. The CODEC 208 may in turn be coupled to a speaker 210 and a microphone 212. The general purpose processor 206 may also be coupled to at least one memory 214. The memory 214 may be a non-transitory tangible computer readable storage medium that stores processor-executable instructions. For example, the instructions may include routing communication data relating to the first or second subscription though a corresponding baseband-RF resource chain. The memory 214 may store operating system (OS), as well as user application software and executable instructions.

The general purpose processor 206 and memory 214 may each be coupled to at least one baseband-modem processor 216. Each SIM 204a, 204b in the wireless device 200 may be associated with a baseband-RF resource chain that includes a baseband-modem processor 216 and an RF resource (i.e., RF front end) 218a, 218b. In various embodiments, baseband-RF resource chains may include physically or logically separate baseband modem processors (e.g., BB1, BB2).

The RF resources 218a, 218b may be coupled to an antennas 220, 221, and may perform transmit/receive functions for the wireless services associated with each SIM 204a, 204b of the wireless device 200. In some embodiments, the RF resources 218a, 218b may be coupled to wireless antennas 220a, 220b for sending and receiving RF signals for the SIMs 204a, 204b thereby enabling the wireless device 200 to perform simultaneous communications with separate networks and/or service associated with the SIMs 204a, 204b. The first and second RF resources 218a, 218b may provide separate transmit and receive functionality, or may include a transceiver that combines transmitter and receiver functions.

In particular embodiments, the general purpose processor 206, memory 214, baseband-modem processor(s) 216, and RF resources 218a, 218b may be included in a system-on-chip device 222. The first and second SIMs 204a, 204b and their corresponding interfaces 202a, 202b may be external to the system-on-chip device 222. Further, various input and output devices may be coupled to components of the system-on-chip device 222, such as interfaces or controllers. Example user input components suitable for use in the wireless device 200 may include, but are not limited to, a keypad 224 and a touchscreen display 226.

In some embodiments, the keypad 224, touchscreen display 226, microphone 212, or a combination thereof, may perform the function of receiving the request to initiate an outgoing call. For example, the touchscreen display 226 may receive a selection of a contact from a contact list or receive a telephone number. In another example, either or both of the touchscreen display 226 and microphone 212 may perform the function of receiving a request to initiate an outgoing call. For example, the touchscreen display 226 may receive selection of a contact from a contact list or to receive a telephone number. As another example, the request to initiate the outgoing call may be in the form of a voice command received via the microphone 212. Interfaces may be provided between the various software modules and functions in the wireless device 200 to enable communication between them, as is known in the art.

In this manner, in a DSDA wireless device, such as the wireless device 200, each RF resource associated with a SIM and a corresponding modem stack may operate as an independent device, despite being co-located and sharing non-network based resources with one another (e.g., user input/output resources, general processor and storage, etc.). While such independent functionality provides multiple user benefits, such as providing the user with essentially multiple different phones in the same physical housing, in some scenarios this benefit is not possible based on the inactivity of a SIM. Therefore, the wireless device may benefit from dynamically allocating use of a corresponding RF resource to provide MIMO operation on a protocol stack associated with another SIM.

MIMO has drawn particular attention in evolutions of wireless communications because MIMO offers significant increases in data throughput by applying a higher spectral efficiency. For example, MIMO plays an important role in modern wireless communication standards such as in the IEEE 802.11n (Wi-Fi), in the 4G, in the 3GPP LTE, in the worldwide interoperability for microwave access (WiMAX) and in the evolved high speed packet access (HSPA+).

In various embodiments, the base stations of the LTE access network (e.g., E-UTRAN 152 in FIG. 1B) may each have multiple antennas, thereby supporting MIMO technology. The use of MIMO technology allows a base station to exploit the spatial domain to support spatial multiplexing—that is, transmitting different streams of data simultaneously on the same frequency to a wireless device. In a conventional wireless device that is configured with multiple antennas, MIMO may provide improvements in channel throughput.

Specifically, MIMO involves mapping of a data stream to multiple parallel data streams and de-mapping multiple received data streams into a single data stream. The data rate in downlink communications may be increased by spatial precoding of each data stream (i.e., applying a scaling of an amplitude and a phase) and transmitting the spatially precoded stream through multiple transmit antennas at the base station. The spatially precoded data streams may therefore arrive at the wireless device (e.g., 102, 200 in FIGS. 1A-2) with different spatial signatures. In some embodiments, the wireless device may recover the data streams using a plurality of RF chains if configured with the correct coding. That is, in order to be able to benefit from MIMO on the downlink, the wireless device must be able to utilize coding on the channels to separate the data from the different paths having the different spatial signatures.

Since the use of multiple RF resources and coding increases processing and battery usage on the wireless device, implementing MIMO generally requires balancing the improvements in performance against costs, size, resulting battery life, etc.

Multi-SIM multi-active wireless communication devices are typically configured with multiple RF chains, and therefore with multiple antennas. In various embodiments, if certain criteria (i.e., MIMO criteria) are met, MIMO may be employed on a high speed network on which an active SIM is camped by repurposing elements of an inactive RF chain.

Referring to FIGS. 1A-2, in various embodiment wireless communication devices, RF chains may be configured as different combinations of antennas. That is, some antennas may have only transmission capability, while others may have only reception capability. In some embodiments, the antennas (e.g., 220a, 220b) may have both transmission and reception capabilities, and the functionality may be switched in use with special purpose control signals. In various embodiments, the antennas may be associated with the same or separate RF resources (e.g., 218a, 218b) in various RF chain combinations depending on the antenna capabilities.

The various embodiments may enable a multi-SIM multi-active wireless communication device to utilize an RF resource associated with an unavailable SIM to provide MIMO operations for an active SIM supporting a high-speed wireless communication standard (e.g., LTE). For example, a SIM may be inactive if the corresponding UICC has been inserted improperly into the wireless device, or if the user has intentionally failed to insert a corresponding UICC into the appropriate slot. In some embodiments, a SIM may be inactive if the user has selected (e.g., through user input) single SIM operation on the wireless device. In some embodiments, a SIM may be inactive if the networks in which the SIM supports registration do not provide coverage to the DSDA device location. For example, a search for a supporting network may be performed for a certain predetermined amount of time, after which the SIM may become inactive.

When one of the SIMs is inactive for a period of time, the SIM's corresponding RF resource may become inactive by being placed in a sleep mode. In various embodiments, the RF resource associated with the inactive SIM (i.e., the “inactive RF resource”) may be used to support MIMO mode for an active SIM in certain circumstances. Specifically, a MIMO manager may be run on the wireless device to determine whether the inactive SIM should be allocated to the active SIM for MIMO operations based on whether various conditions relating to the SIMs, RF resources, and/or serving network are met. Such conditions may be designed to ensure that the throughput gain added by MIMO will be worth the additional processing and power consumption resulting from operation of another active RF resource. In various embodiments, the MIMO manager may be implemented as one or more software module/controller operating on a processor of the wireless device.

In some embodiments, the MIMO manager may evaluate whether an RF resource that is independent of other SIMs is mapped to the inactive SIM. In other words, the MIMO manager may ensure that each SIM is associated with an RF resource (e.g., DSDA configuration) as opposed to a single, shared RF resource that is used by multiple SIMs.

In some embodiments, the MIMO manager may also evaluate whether the inactive SIM has been inactive for a threshold period of time such that the probability of the inactive SIM remaining inactive is increased. That is, the MIMO manager may set a threshold period of time to avoid evaluating for possible MIMO operation if the inactivity of the SIM is due, for example, to a temporary out-of-service condition, to the user switching one SIM for another, to the user accidentally activating single SIM mode, etc. In some embodiments, the threshold period of time may be satisfied upon expiration of a timer.

In some embodiments, the MIMO manager may also evaluate whether an active SIM is camped for both voice and data communications on a network that supports high-speed wireless communications, such as an LTE network. In some embodiments, the MIMO manager may also evaluate whether the inactive RF resource is capable of operating using the high-speed wireless communication standard. In some embodiments, the MIMO manager may evaluate whether the serving network for the active SIM supports MIMO operation.

Once these criteria are met, the MIMO manager may allocate the inactive RF resource to the active SIM that is camped on the high speed network, thereby enabling MIMO mode on the wireless device for communications on the high-speed network via both RF resources.

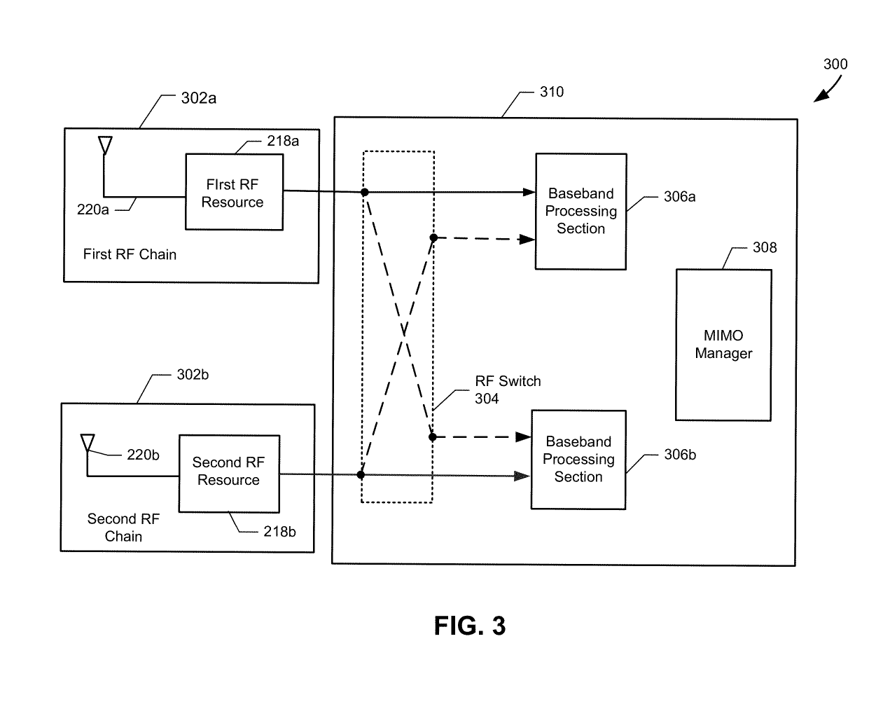

FIG. 3 illustrates a configuration 300 of RF elements that may interact in a multi-SIM wireless communication device to provide MIMO operations according to various embodiments. Referring to FIGS. 1 and 2, such receive elements may be functions and/or components of the wireless devices 102, 200. With reference to FIGS. 1-3, in the configuration 300, a first RF chain 302a may include the first antenna 220a and the first RF resource/front end 218a. Functions and components of the first RF resource 218a may include, but are not limited to, receiver and/or transmitter units, analog-to-digital (A/D) and digital-to analog (D/A) converters, and digital up and down converters, the functions and details of which are known in the art of digital transceiver design. Similarly, the second RF chain 302b may include a second antenna 220b and the second RF resource/front end 218b. Components of the second RF resource 218b may also include, but are not limited to, receiver and/or transmitter units, analog-to-digital (A/D) and digital-to analog (D/A) converters, and digital up and down converters. During operation in the various embodiments, the first RF chain 302a may be adapted to receive signals from and transmit signals to a high-speed network (e.g., network 104).

Baseband processing sections 306a, 306b may represent functions of the baseband modem processor 216 associated with the first and second RF chains 302a, 302b, respectively. The baseband processing sections 306a, 306b in various embodiments manage radio control functions including additional receive and transmit functions (not shown). For example, the transmit functions that may be managed by baseband processing sections 306a, 306b may include encoding, interleaving, and multiplexing at the symbol rate, and channelization, spreading, and modulation at the chip rate. The receive functions that may be managed by the baseband processing sections 306a, 306b may include rake receiving, and symbol combining, and finger control at the chip rate, and demultiplexing, deinterleaving, and decoding at the symbol rate. A variety of other receive functions that are not shown may nevertheless be included in the first and second RF chains 302a, 302b, as will be understood by those of skill in the art.

The various embodiments may include one or more RF switches, such as RF switch 304, which may be implemented according to any of a number of suitable configurations. By changing the state of the RF switch 304, the path for signals received on each antenna 220a, 220b through each RF resources 218a, 218b, may be controlled. In particular, control of the RF switch 304 may be performed by a MIMO manager 308. MIMO operation may be enabled when the received signal input to the first RF chain 302a is configured to operate in conjunction with components providing signaling for the second SIM (SIM-2) 204b (e.g., baseband processing section 306b), or when the received signal input to the second RF chain 302b is configured to operate in conjunction with components providing signaling for the first SIM (SIM-1) 204a (e.g., baseband processing section 306a). These configurations may be the result of the RF switch 304, which may be capable of switching when either the first SIM 204a or the second SIM 204b is inactive.

Variations in the first RF chain 302a and second RF chain 302b may exist depending on the design of the wireless device 200. Those of ordinary skill in the art will recognize that in the various embodiments, the switch configurations may be applied with any numbers of antennas, RF chains, etc.

Moreover, while the baseband processing sections 306a and 306b, and/or the MIMO manager 308 may be discrete components, they may be integrated in a number of ways, either with one another or with other components of the wireless device 200. In particular embodiments, some components, such as the baseband processing sections 306a and 306b, and/or the MIMO manager 308 may be included in a system-on-chip device 310.

Separate units of the baseband-modem processor 216 of the wireless device 200 may be implemented as separate structures or as separate logical units within the same structure, and may be configured to execute software including at least two protocol stacks/modem stacks associated with at least two SIMs, respectively. The SIMs and associated modem stacks may be configured to support a variety of communication services that fulfill different user requirements. Further, a particular SIM may be provisioned with information to execute different signaling procedures for accessing a domain of the core network associated with these services and for handling data thereof.

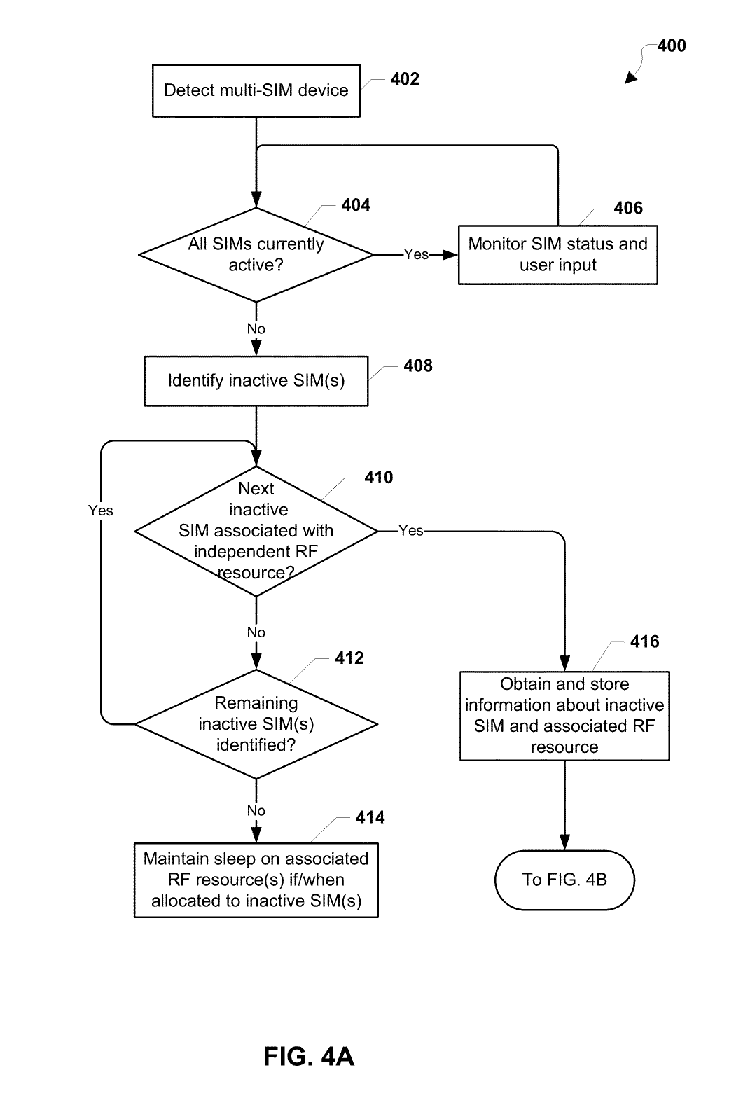

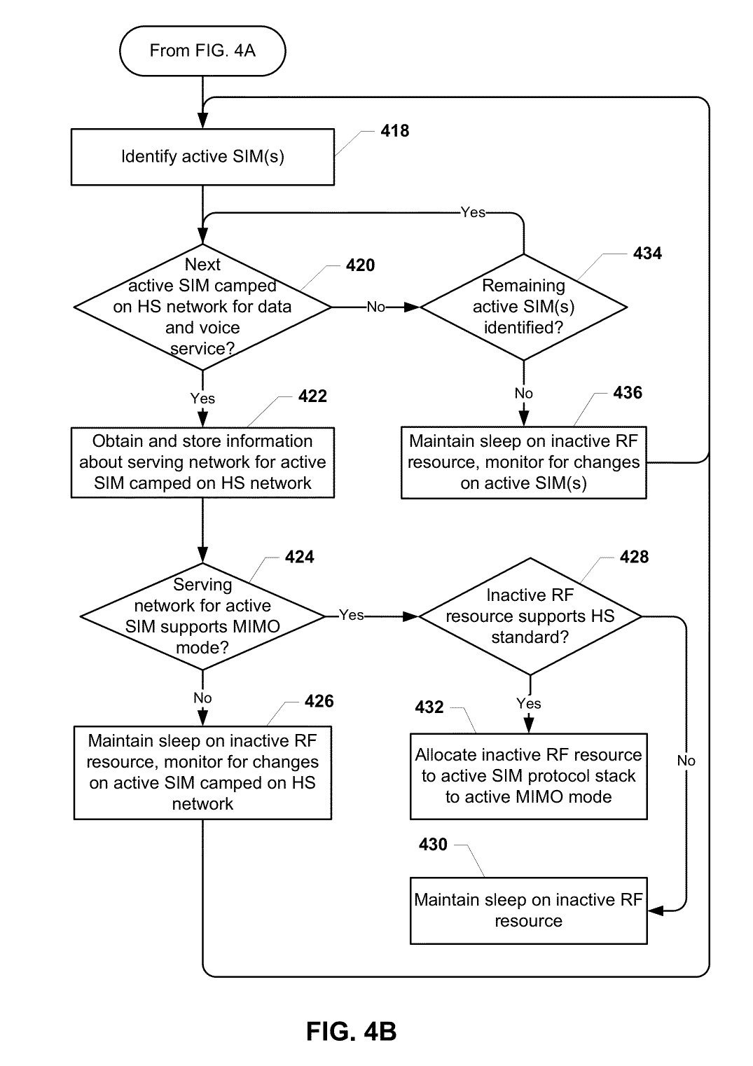

FIGS. 4A and 4B illustrate an embodiment method 400 of dynamic MIMO management on a wireless device, such as a DSDA device. With reference to FIGS. 1-4B, the operations of the method 400 may be implemented in the MIMO manager 308 by one or more processors of the wireless device 200, such as the general purpose processor 206 and/or baseband modem processor(s) 216, or a separate controller (not shown) that may be coupled to the memory 214 and to the baseband modem processor(s) 216.

While the various embodiments describe the MIMO management processes among two SIMs for use of one RF resource, the various embodiment processes may be implemented to manage various combinations of more than two RF resources and/or SIMs. For example, the MIMO manager may be configured to allocate use of two RF resources respectively associated with two inactive SIMs to an active third SIM, three inactive RF resources to an active fourth SIM, etc. In various embodiments, the MIMO module may output control signals to the protocol stacks associated with the first and second SIMs and/or to the first and second RF resources.

The references to the first SIM (SIM-1) and RF resource, and the second SIM (SIM-2) and RF resource are arbitrary and used merely for the purposes of describing the embodiments. The wireless device processor may assign any indicator, name or other designation to differentiate the SIMs and associated protocol stacks and RF resources. Further, embodiment methods apply the same regardless of which SIM is benefiting from MIMO operations. For example, the first SIM in the wireless device may be inactive such that the first RF resource is available to enable MIMO mode on the second SIM. Subsequently, the first SIM may become active and the second SIM inactive, thereby enabling the second RF resource to be available to enable MIMO mode on the first SIM. While RF resource assignment depends on the particular radio access technologies associated with each SIM and rules configured to be implemented by the MIMO manager, a MIMO management process may proceed according to method 400.

In block 402, the wireless device processor may detect that the wireless device is a multi-SIM wireless device. In determination block 404, the wireless device processor may determine whether all of the SIMs of the wireless device are currently active (i.e., available to perform communications and/or idle mode processes). In various embodiments, the wireless device processor may be configured to receive information about SIM availability by querying the one or more protocol stacks implemented to manage mobility and communication functions on the SIMs. In response to determining that all of the SIMs of the wireless device are currently active (i.e., determination block 404=“Yes”), the wireless device processor may monitor the SIM status and user input in block 406 in order to detect when a SIM becomes inactive. Such inactivity may be deliberate by the user (e.g., indicated by user input, preset user settings, etc.), or may be the result of other conditions (e.g., loss of service, release or failure of SIM card, etc.) Until at least one SIM is inactive (i.e., as long as determination block 404=“Yes”), the wireless device processor may continue to monitor the SIM status and user input. In some embodiments, a SIM may be counted as still active until it has been inactive for a threshold period of time. In this manner, the probability of reporting inactivity of a SIM that is due to a brief or accidental condition (e.g., temporary network fluctuation, incorrect user input, etc.) may be reduced. In some embodiments, such threshold time may be implemented in a countdown timer.

In response to determining that fewer than all of the SIMs of the wireless device are currently active (e.g., determination block 404=“No”), the wireless device processor may identify each inactive SIM in block 408. In determination block 410, the wireless device processor may determine whether a next inactive SIM identified from block 408 is associated with one or more independent RF resource (i.e., an associated RF resource that is normally mapped to communications for only that SIM, as opposed to shared for communications on multiple SIMs). In response to determining that the next inactive SIM is not associated with an independent RF resource (i.e., determination block 410=“No”), in determination block 412 the wireless device processor may determine whether there are any remaining inactive SIMs identified from block 408. In response to determining that remaining inactive SIMs were identified (i.e., determination block 412=“Yes”), the wireless device processor may return to determination block 410 for the next inactive SIM.

In response to determining that no remaining inactive SIMs were identified (i.e., determination block 412=“No”), in block 414 the wireless device processor may maintain a low-power sleep state on any RF resource(s) associated with that inactive SIM, if and when the associated RF resource is allocated for use by that SIM.

In response to determining that the next inactive SIM is associated with an independent RF resource (i.e., determination block 410=“Yes”), in block 416 the wireless device processor may obtain information about the inactive SIM and the associated RF resource (i.e., the “inactive RF resource”), which may be stored in a cache or other temporary data structure. The information may include, for example, various capabilities and settings associated with the inactive SIM. In particular, the wireless device processor may store information identifying the service provider networks in which the inactive SIM can register during normal operation, the RAT(s) supported by the associated RF resource, the number of and/or configuration of the antenna or antenna array associated with the RF resource, etc. In some embodiments, the information may be retrieved from data stored on the inactive SIM and/or querying operations on the protocol stack associated with the second SIM. The wireless device processor may proceed to block 418.

In block 418, the wireless device processor may identify each active SIM on the wireless device. In determination block 420, the wireless device processor may determine whether a next active SIM from block 418 is camped on a high-speed network (i.e., a wireless network configured to support high-speed communications, such as an LTE network) for both data and voice services. For example, in various embodiments the performance improvement gained from MIMO operation when the wireless device is only partially using high-speed communications may be too low to outweigh the cost of the added processing and power consumption.

In response to determining that the next active SIM is camped on the high-speed network for both data and voice services (i.e., determination block 420=“Yes”), in block 422 the wireless device processor may obtain and store information about the serving network of the active SIM camped on the high-speed network. Such information may include, for example, the particular network identity, control channel information, the RAT(s) implemented by the serving network, etc. In some embodiments, the wireless device processor may retrieve such information from data stored on the active SIM, and/or from system information read by an RF resource associated with the active SIM, which may be processed through the corresponding protocol stack during normal cell selection processes. In some embodiments, the wireless device processor may additionally or alternatively pass a direct request for information to the RF resource associated with the first SIM.

In determination block 424, the wireless device processor may determine whether the serving network of the active SIM supports MIMO mode. In response to determining that the serving network of the active SIM does not support MIMO mode (i.e., determination block 424=“No”), in block 426 the wireless device processor may maintain a low-power sleep state on the inactive RF resource, and monitor for changes on the active SIM that is camped on the high-speed network. For example, the wireless device processor may monitor the protocol stack associated with the active SIM for any cell or network reselection, service interruption, change in the registration status of the active SIM for voice and data services, etc. The wireless device processor may also monitor the active SIM for any transition from active to inactive, which may be identified, for example, by a loss of power/signaling in the corresponding SIM slot. The wireless device processor may, either periodically or in response to a change in the active SIM, return to block 418 to identify all active SIMs. The wireless device processor may repeat determination block 420, as well as the remaining steps in method 400 following determination block 420.

In response to determining that the serving network of the active SIM supports MIMO mode (i.e., determination block 424=“Yes”), in determination block 428 the wireless device processor may determine whether the inactive RF resource supports the high-speed communication standard employed by the active SIM. In various embodiments, the wireless device processor may retrieve the previously-stored information about the serving network (e.g., from block 422) and the previously-stored information about the inactive SIM and associated RF resource (e.g., from block 416). In response to determining that the inactive RF resource does not support the high-speed communication standard employed by the active SIM (i.e., determination block 428=“No”), the wireless device processor may maintain a low-power sleep state on the inactive RF resource in block 430.

In response to determining that the inactive RF resource supports the high-speed communication standard (i.e., determination block 428=“Yes”), in block 432 the wireless device processor may activate MIMO mode on the active SIM by allocating the inactive RF resource to the protocol stack associated with the active SIM. In this manner, the protocol stack associated with the active SIM may control at least two RF resources for communications in the high-speed network.

In response to determining that a next active SIM is not camped on a high-speed network for both voice and data services (i.e., determination block 420=“No”), the wireless device processor may determine whether there are any remaining active SIMs identified from block 418) in determination block 434. In response to determining that there are remaining active SIMs identified (i.e., determination block 434=“Yes”), the wireless device processor may return to determination block 420 for the next active SIM. In response to determining that there are no remaining active SIMs identified (i.e., determination block 434=“No”), in block 436 the wireless device processor may maintain a low-power sleep state on the inactive RF resource, and monitor for changes on the active SIM or SIMs. For example, the wireless device processor may monitor the protocol stack associated with the active SIM for any cell or network reselection, service interruption, change in the registration status of an active SIM for voice and data services, etc. The wireless device processor may also monitor the active SIM for any transition from active to inactive, which may be identified, for example, by a loss of power/signaling in the corresponding SIM slot. The wireless device processor may, either periodically or in response to a change in an active SIM, return to block 418 and identify all active SIMs. The wireless device processor may repeat determination block 420, as well as the remaining steps in method 400 following determination block 420.

Management of RF resources by the MIMO manager (or the processor executing a MIMO manager module) may be based on the particular radio access technologies enabled by each SIM and the criteria with which the MIMO manager processes are configured. While described with reference to WCDMA and/or GSM networks, the embodiments herein may be implemented for any of a number of radio access technologies.

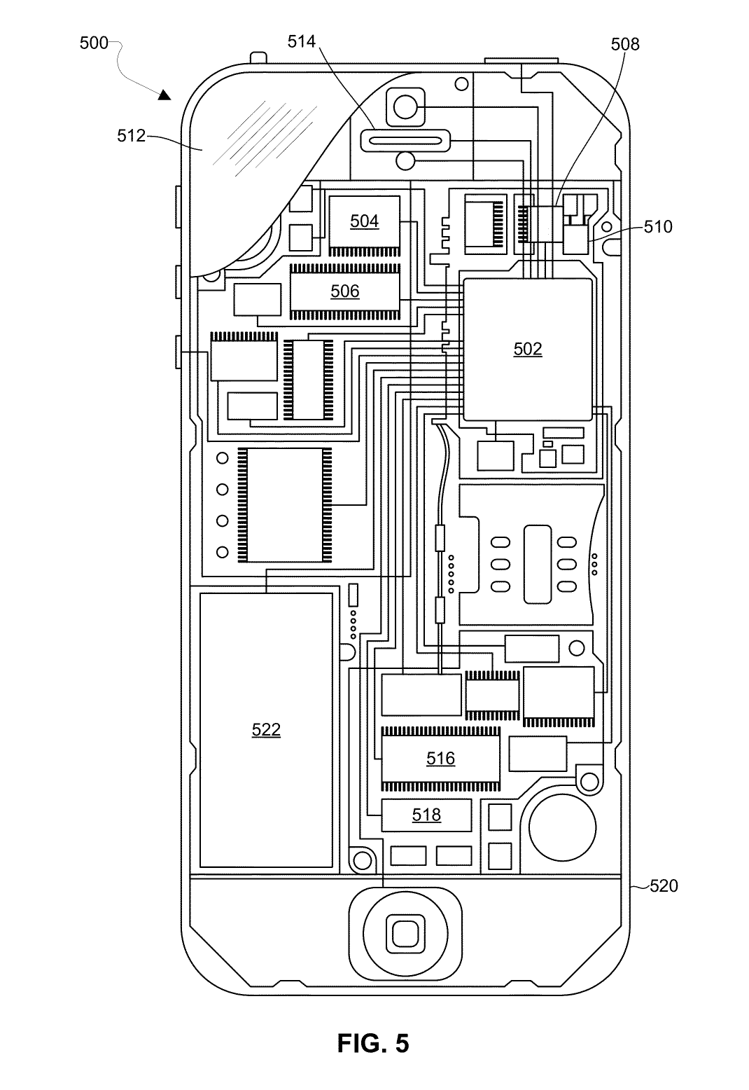

Various embodiments (including, but not limited to, the embodiments discussed above with reference to FIGS. 4A and 4B) may be implemented in any of a variety of wireless devices, an example of which is illustrated in FIG. 5. For example, with reference to FIGS. 1-5, a wireless device 500 (which may correspond, for example, to the wireless devices 102 and/or 200 in FIGS. 1A-2) may include a processor 502 coupled to a touchscreen controller 504 and an internal memory 506. The processor 502 may be one or more multicore ICs designated for general or specific processing tasks. The internal memory 506 may be volatile or non-volatile memory, and may also be secure and/or encrypted memory, or unsecure and/or unencrypted memory, or any combination thereof.

The touchscreen controller 504 and the processor 502 may also be coupled to a touchscreen panel 512, such as a resistive-sensing touchscreen, capacitive-sensing touchscreen, infrared sensing touchscreen, etc. The wireless device 500 may have one or more radio signal transceivers 508 (e.g., Peanut®, Bluetooth®, Zigbee®, Wi-Fi, RF radio) and antennas 510, for sending and receiving, coupled to each other and/or to the processor 502. The transceivers 508 and antennas 510 may be used with the above-mentioned circuitry to implement the various wireless transmission protocol stacks and interfaces. The wireless device 500 may include a cellular network wireless modem chip 516 that enables communication via a cellular network and is coupled to the processor. The wireless device 500 may include a peripheral device connection interface 518 coupled to the processor 502. The peripheral device connection interface 518 may be singularly configured to accept one type of connection, or multiply configured to accept various types of physical and communication connections, common or proprietary, such as USB, FireWire, Thunderbolt, or PCIe. The peripheral device connection interface 518 may also be coupled to a similarly configured peripheral device connection port (not shown). The wireless device 500 may also include speakers 514 for providing audio outputs. The wireless device 500 may also include a housing 520, constructed of a plastic, metal, or a combination of materials, for containing all or some of the components discussed herein. The wireless device 500 may include a power source 522 coupled to the processor 502, such as a disposable or rechargeable battery. The rechargeable battery may also be coupled to the peripheral device connection port to receive a charging current from a source external to the wireless device 500.

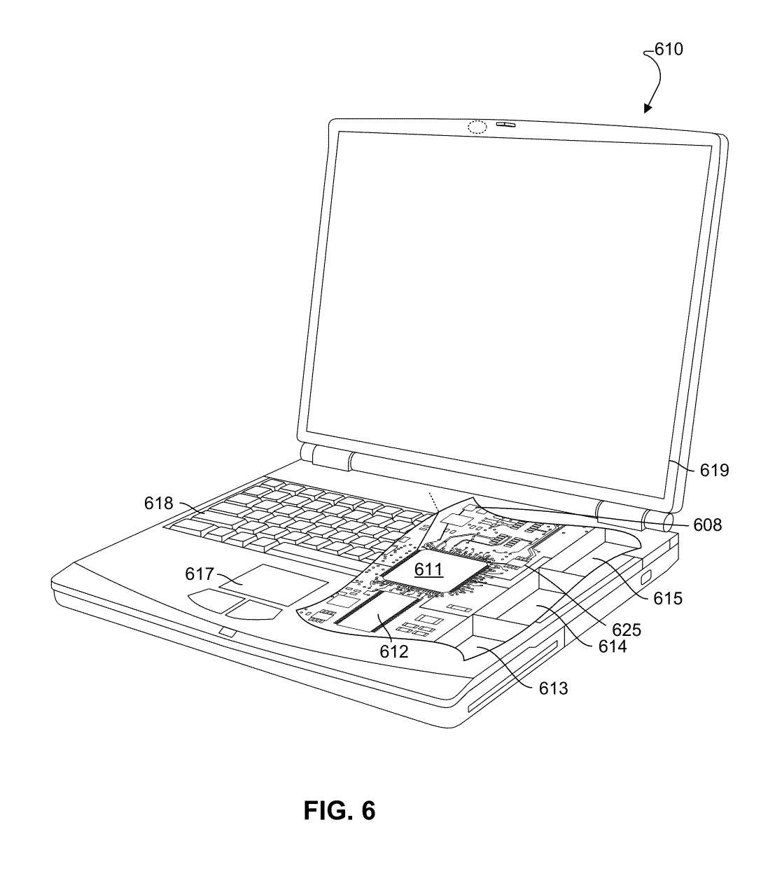

Various embodiments (including, but not limited to, the embodiments discussed above with reference to FIGS. 1A-2), may also be implemented within a variety of personal computing devices, an example of which is illustrated in FIG. 6. For example, with reference to FIGS. 1-6, a laptop computer 600 (which may correspond, for example, to the wireless devices 102, 200 in FIGS. 1A-2) may include a touchpad touch surface 617 that serves as the computer's pointing device, and thus may receive drag, scroll, and flick gestures similar to those implemented on wireless computing devices equipped with a touch screen display and described above. A laptop computer 600 will typically include a processor 611 coupled to volatile memory 612 and a large capacity nonvolatile memory, such as a disk drive 613 of Flash memory. The computer 600 may also include a floppy disc drive 614 and a compact disc (CD) drive 615 coupled to the processor 611. The computer 600 may also include a number of connector ports coupled to the processor 611 for establishing data connections or receiving external memory devices, such as a USB or FireWire® connector sockets, or other network connection circuits for coupling the processor 611 to a network. In a notebook configuration, the computer housing includes the touchpad 617, the keyboard 618, and the display 619 all coupled to the processor 611. Other configurations of the computing device may include a computer mouse or trackball coupled to the processor (e.g., via a USB input) as are well known, which may also be used in conjunction with various embodiments.

With reference to FIGS. 1-6, the processors 502 and 611 may be any programmable microprocessor, microcomputer or multiple processor chip or chips that can be configured by software instructions (applications) to perform a variety of functions, including the functions of various embodiments described above. In some devices, multiple processors may be provided, such as one processor dedicated to wireless communication functions and one processor dedicated to running other applications. Typically, software applications may be stored in the internal memory 506, 612 and 613 before they are accessed and loaded into the processors 502 and 611. The processors 502 and 611 may include internal memory sufficient to store the application software instructions. In many devices the internal memory may be a volatile or nonvolatile memory, such as flash memory, or a mixture of both. For the purposes of this description, a general reference to memory refers to memory accessible by the processors 502, 611, including internal memory or removable memory plugged into the device and memory within the processor 502 and 611, themselves.

The foregoing method descriptions and the process flow diagrams are provided merely as illustrative examples and are not intended to require or imply that the steps of various embodiments must be performed in the order presented. As will be appreciated by one of skill in the art the order of steps in the foregoing embodiments may be performed in any order. Words such as “thereafter,” “then,” “next,” etc. are not intended to limit the order of the steps; these words are simply used to guide the reader through the description of the methods. Further, any reference to claim elements in the singular, for example, using the articles “a,” “an” or “the” is not to be construed as limiting the element to the singular.

While the terms “first” and “second” are used herein to describe data transmission associated with a SIM and data receiving associated with a different SIM, such identifiers are merely for convenience and are not meant to limit the various embodiments to a particular order, sequence, type of network or carrier.

The various illustrative logical blocks, modules, circuits, and algorithm steps described in connection with the embodiments disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present invention.

The hardware used to implement the various illustrative logics, logical blocks, modules, and circuits described in connection with the aspects disclosed herein may be implemented or performed with a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general-purpose processor may be a microprocessor, but, in the alternative, the processor may be any conventional processor, controller, microcontroller, or state machine A processor may also be implemented as a combination of computing devices, e.g., a combination of a DSP and a microprocessor, a plurality of microprocessors, one or more microprocessors in conjunction with a DSP core, or any other such configuration. Alternatively, some steps or methods may be performed by circuitry that is specific to a given function.

In one or more exemplary aspects, the functions described may be implemented in hardware, software, firmware, or any combination thereof. If implemented in software, the functions may be stored as one or more instructions or code on a non-transitory computer-readable medium or non-transitory processor-readable medium. The steps of a method or algorithm disclosed herein may be embodied in a processor-executable software module which may reside on a non-transitory computer-readable or processor-readable storage medium. Non-transitory computer-readable or processor-readable storage media may be any storage media that may be accessed by a computer or a processor. By way of example but not limitation, such non-transitory computer-readable or processor-readable media may include RAM, ROM, EEPROM, FLASH memory, CD-ROM or other optical disk storage, magnetic disk storage or other magnetic storage devices, or any other medium that may be used to store desired program code in the form of instructions or data structures and that may be accessed by a computer. Disk and disc, as used herein, includes compact disc (CD), laser disc, optical disc, digital versatile disc (DVD), floppy disk, and blu-ray disc where disks usually reproduce data magnetically, while discs reproduce data optically with lasers. Combinations of the above are also included within the scope of non-transitory computer-readable and processor-readable media. Additionally, the operations of a method or algorithm may reside as one or any combination or set of codes and/or instructions on a non-transitory processor-readable medium and/or computer-readable medium, which may be incorporated into a computer program product.

The preceding description of the disclosed embodiments is provided to enable any person skilled in the art to make or use the present invention. Various modifications to these embodiments will be readily apparent to those skilled in the art, and the generic principles defined herein may be applied to other embodiments without departing from the spirit or scope of the invention. Thus, the present invention is not intended to be limited to the embodiments shown herein but is to be accorded the widest scope consistent with the following claims and the principles and novel features disclosed herein.

What is claimed is:

1. A method for managing multiple-input multiple-output (MIMO) mode on a multi-subscriber identification module (SIM) wireless communication device having at least two SIMs and at least two radio frequency (RF) resources, the method comprising:
determining whether all of the SIMs of the wireless communication device are in an active state;
identifying each active SIM and each RF resource associated with an inactive SIM in response to determining that not all of the SIMs are in the active state;
determining whether at least one identified active SIM and at least one identified RF resource satisfy multiple-input multiple-output (MIMO) criteria; and
allocating, for use in MIMO operations, the at least one identified RF resource to a protocol stack associated with a selected one of the at least one identified active SIM in response to determining that at least one identified active SIM and at least one identified RF resource satisfy the MIMO criteria.

2. The method of claim 1, wherein determining whether at least one identified RF resource satisfies the MIMO criteria comprises:
determining, for each identified RF resource, whether communication activity is normally mapped to a protocol stack associated with a single SIM.

3. The method of claim 2, further comprising:
obtaining information about the identified RF resources, wherein the information comprises for each identified RF resource at least one of:
a set of radio access technologies supported by the identified RF resource; and
a set of service provider networks in which the protocol stack associated with the single SIM can register; and
storing the obtained information about the identified RF resources.

4. The method of claim 3, wherein determining whether at least one identified active SIM satisfies the MIMO criteria comprises:
determining, for each identified active SIM, whether an associated protocol stack is operating in a high-speed communication network; and
for each identified active SIM operating in a high-speed communication network, determining whether the associated protocol stack is camped for both voice and data service on a serving cell of the high-speed communication network.

5. The method of claim 4, further comprising storing information about the high-speed communication network for each identified active SIM in response to determining that the associated protocol stack is operating in the high-speed communication network and is camped for both voice and data service on a serving cell of the high-speed communication network, wherein the stored information about the high-speed communication network identifies at least one communication protocol implemented by the high-speed communication network.

6. The method of claim 5, wherein storing information about the high-speed communication network further comprises storing information about the serving cell.

7. The method of claim 5, wherein the at least one communication protocol implemented by the high-speed communication network uses at least one of long term evolution (LTE), evolved high-speed packet access (HSPA+), worldwide interoperability for microwave access (WiMAX), and IEEE 802.11 (Wi-Fi).

8. The method of claim 5, wherein determining whether at least one identified RF resource satisfies the MIMO criteria further comprises:
comparing the information stored about the identified RF resources to the information stored about high-speed communication network; and
determining, based on the comparison, whether any identified RF resource associated with an inactive SIM supports a radio access technology capable of using the high-speed communication network.

9. The method of claim 6, wherein determining whether at least one identified active SIM satisfies the MIMO criteria further comprises determining whether the serving cell supports MIMO mode.

10. The method of claim 9, further comprising:
maintaining a low-power sleep state on the identified RF resources in response to determining that the MIMO criteria are not satisfied.

11. The method of claim 9, further comprising:
maintaining a low-power sleep state on the identified RF resources in response in response to determining that the serving cell does not support MIMO mode;
monitoring the protocol stack associated with the identified active SIMs; and
repeating identifying each active SIM upon detecting a change in the protocol stack associated with the one or more identified active SIM.

12. The method of claim 1, further comprising identifying inactive SIMs as being at least one of:
out-of-service such that an associated protocol stack is not camped on any network;
stored on a card that has been removed from or improperly inserted into a slot of the wireless communication device; and
deliberately deactivated as a result of user input.

13. The method of claim 1, further comprising:
maintaining a low-power sleep state on the identified RF resources in response to determining that the MIMO criteria are not satisfied.

14. A wireless communication device, comprising:
at least two radio frequency (RF) resources configured to connect to at least two subscriber identity modules (SIMs); and
a processor coupled to the at least two RF resources and configured with processor-executable instructions to:
determine whether all of the SIMs of the wireless communication device are in an active state;
identify each active SIM and each RF resource associated with an inactive SIM in response to determining that not all of the SIMs are in the active state;
determine whether at least one identified active SIM and at least one identified RF resource satisfy multiple-input multiple-output (MIMO) criteria; and
allocate, for use in MIMO operations, the at least one identified RF resource to a protocol stack associated with a selected one of the at least one identified active SIM in response to determining that at least one identified active SIM and identified RF resource satisfy the MIMO criteria.

15. The wireless communication device of claim 14, wherein the processor is further configured with processor-executable instructions to determine whether at least one identified RF resource satisfies the MIMO criteria by:
determining, for each identified RF resource, whether communication activity is normally mapped to a protocol stack associated with a single SIM.

16. The wireless communication device of claim 15, wherein the processor is further configured with processor-executable instructions to:
obtain information about the identified RF resources, wherein the information comprises for each identified RF resource at least one of:
a set of radio access technologies supported by the identified RF resource; and
a set of service provider networks in which the protocol stack associated with the single SIM can register; and
store the obtained information about the identified RF resources.

17. The wireless communication device of claim 16, wherein the processor is further configured with processor-executable instructions to determine whether at least one identified active SIM satisfies the MIMO criteria by:
determining, for each identified active SIM, whether an associated protocol stack is operating in a high-speed communication network; and
determining for each identified active SIM operating in a high-speed communication network whether the associated protocol stack is camped for both voice and data service on a serving cell of the high-speed communication network.

18. The wireless communication device of claim 17, wherein the processor is further configured with processor-executable instructions to store information about the high-speed communication network for each identified active SIM in response to determining that the associated protocol stack is operating in the high-speed communication network and is camped for both voice and data service on a serving cell of the high-speed communication network, wherein the stored information about the high-speed communication network identifies at least one communication protocol implemented by the high-speed communication network.

19. The wireless communication device of claim 18, wherein the processor is further configured with processor-executable instructions to store information about the high-speed communication network by storing information about the serving cell.

20. The wireless communication device of claim 18, wherein the at least one communication protocol implemented by the high-speed communication network uses at least one of long term evolution (LTE), evolved high-speed packet access (HSPA+), worldwide interoperability for microwave access (WiMAX), and IEEE 802.11 (Wi-Fi).

21. The wireless communication device of claim 18, wherein the processor is further configured with processor-executable instructions to determine whether at least one identified RF resource satisfies the MIMO criteria by:
comparing the information stored about the identified RF resources to the information stored about high-speed communication network; and
determining, based on the comparison, whether any identified RF resource associated with an inactive SIM supports a radio access technology capable of using the high-speed communication network.

22. The wireless communication device of claim 19, wherein the processor is further configured with processor-executable instructions to determine whether at least one identified active SIM satisfies the MIMO criteria by determining whether the serving cell supports MIMO mode.

23. The wireless communication device of claim 22, wherein the processor is further configured with processor-executable instructions to:
maintain a low-power sleep state on the identified RF resources in response to determining that the MIMO criteria are not satisfied.

24. The wireless communication device of claim 22, wherein the processor is further configured with processor-executable instructions to:
maintain a low-power sleep state on the at least one identified RF resource in response in response to determining that the serving cell does not support MIMO mode;
maintain the protocol stack associated with the at least one identified active SIM; and
repeat identifying each active SIM upon detecting a change in the protocol stack associated with the at least one identified active SIM.

25. The wireless communication device of claim 14, wherein the processor is further configured with processor-executable instructions to identify inactive SIMs as being at least one of:
out-of-service such that an associated protocol stack is not camped on any network;
stored on a card that has been removed from or improperly inserted into a slot of the wireless communication device; and
deliberately deactivated as a result of user input.

26. The wireless communication device of claim 14, wherein the processor is further configured with processor-executable instructions to:
maintain a low-power sleep state on the identified RF resources associated in response to determining that the MIMO criteria are not satisfied.

27. A wireless communication device, comprising:
at least two radio frequency (RF) resources configured to connect to at least two subscriber identity modules (SIMs);
means for determining whether all of the SIMs of the wireless communication device are in an active state;
means for identifying each active SIM and each RF resource associated with an inactive SIM in response to determining that not all of the SIMs are in the active state;
means for determining whether at least one identified active SIM and at least one identified RF resource satisfy multiple-input multiple-output (MIMO) criteria; and
means for allocating, for use in MIMO operations, the at least one identified RF resource to a protocol stack associated with a selected one of the at least one identified active SIM in response to determining that at least one identified active SIM and at least one identified RF resource satisfy the MIMO criteria.

28. A non-transitory processor-readable storage medium having stored thereon processor-executable instructions configured to cause a processor of a wireless communication device having at least two radio frequency (RF) resources associated with at least two subscriber identity modules (SIMs) to perform operations comprising:
determining whether all of the SIMs of the wireless communication device are in an active state;
identifying each active SIM and each RF resource associated with an inactive SIM in response to determining that not all of the SIMs are in the active state;
determining whether at least one identified active SIM and at least one identified RF resource satisfy multiple-input multiple-output (MIMO) criteria; and
allocating, for use in MIMO operations, the at least one identified RF resource to a protocol stack associated with a selected one of the at least one identified active SIM in response to determining that at least one identified active SIM and at least one identified RF resource satisfy the MIMO criteria.
